(19) United States
(12) Patent Application Publication
(10) Pub. No.: US 2011/0317190 A1
(43) Pub. Date: Dec. 29, 2011

(54) IMAGE FORMING APPARATUS

(75) Inventor: Kazunori Miyake, Abiko-shi (JP)

(73) Assignee: CANON KABUSHIKI KAISHA, Tokyo (JP)

(21) Appl. No.: 13/151,489

(22) Filed: Jun. 2, 2011

(30) Foreign Application Priority Data
Jun. 28, 2010 (JP) 2010-146562

(51) Int. Cl. G06K 15/00

(52) U.S. Cl. 358/1.13

(57) ABSTRACT

An image forming apparatus, including: an image reading unit configured to continuously read image information from a plurality of originals; and an image forming unit configured to form, on a recording medium at a first speed, an image based on image information of a first original that is read by the image reading unit, wherein, when the image forming unit has completed forming the image based on the image information of the first original before the image reading unit completes reading image information of a second original succeeding to the first original, the image forming unit is decelerated to a second speed lower than the first speed.

### BACKGROUND OF THE INVENTION

1. Field of the Invention

The present invention relates to an image forming apparatus for forming an image on a recording medium.

2. Description of the Related Art

As a conventional image forming apparatus, there is an image forming apparatus for forming an image on a recording medium by using an electrophotographic image forming process. The image forming apparatus is typified by, for example, an electrophotographic copying machine, an electrophotographic printer (for example, color laser beam printer and color LED printer), a multifunction printer (MFP), a facsimile apparatus, and a word processor. Further, both a monochrome image forming apparatus and a color image forming apparatus are included as the image forming apparatus.

The recording medium refers to a transfer material on which the image forming apparatus forms an image. For example, the recording medium is paper, an OHP sheet, or a fabric.

As one of the full-color image forming systems of the image forming apparatus that are currently becoming mainstream, there is a four-station tandem image forming system, in which four photosensitive drums are arranged along a transfer belt. In this system, developer images (hereinafter, referred to as toner images) of cyan (C), magenta (M), yellow (Y), and black (K) are formed on the respective photosensitive drums, and the toner images are sequentially transferred onto a single recording medium, to thereby obtain a color image.

In such an image forming apparatus, during a period between a preceding image forming operation and a succeeding image forming operation (hereinafter, referred to as inter-sheet gap), an image forming unit rotates the photosensitive drums and an intermediate transfer belt in a state in which the photosensitive drums are held into contact with the intermediate transfer belt, until image formation for a succeeding original is started. Consequently, the photosensitive drums, cleaning blades pressed against the photosensitive drums, the intermediate transfer belt, and other members are worn out. Such unnecessary wear or exhaustion, that is, consumption, may increase the frequency of cartridge replacement and also reduce the life of the intermediate transfer belt, and thus is not preferred.

To solve this problem, Japanese Patent Application Laid-Open Nos. H03-288173, H06-258914, and H06-102776 disclose the image forming apparatus that employs a system in which the transfer belt (recording medium conveying belt) is moved apart from the photosensitive drums. In this system, during a period from the end of image formation for a preceding recording medium until the start of image formation for a succeeding recording medium, the transfer belt is moved apart from the photosensitive drums which are not in use.

However, the inventions described in Japanese Patent Application Laid-Open Nos. H03-288173, H06-258914, and H06-102776 require a space for moving the transfer belt apart from the photosensitive drums which are not in use, and also require a drive mechanism therefor, which leads to a problem of increase in size and cost of the image forming apparatus.

### SUMMARY OF THE INVENTION

In order to solve the above-mentioned problem, the present invention provides an image forming apparatus, including: an image reading unit configured to continuously read image information from a plurality of originals; and an image forming unit configured to form, on a recording medium at a first speed, an image based on image information of a first original which is read by the image reading unit, wherein, when the image forming unit has completed forming the image based on the image information of the first original before the image reading unit completes reading image information of a second original succeeding to the first original, the image forming unit is decelerated to a second speed lower than the first speed.

Further features of the present invention will become apparent from the following description of exemplary embodiments with reference to the attached drawings.

### BRIEF DESCRIPTION OF THE DRAWINGS

FIG. 1 is a sectional view of an image forming apparatus according to an embodiment of the present invention.

FIG. 2 is a block diagram illustrating configurations of control units of the image forming apparatus according to the embodiment of the present invention.

FIG. 3 is a timing chart illustrating a relationship between image reading and image formation for color originals in the image forming apparatus according to the embodiment of the present invention.

FIG. 4A is a flow chart illustrating an operation procedure of the image reading for color originals in the image forming apparatus according to the embodiment of the present invention.

FIG. 4B is a flow chart illustrating an operation procedure of the image formation for color originals in the image forming apparatus according to the embodiment of the present invention.

FIG. 5 is a timing chart illustrating a relationship between image reading and image formation for monochrome originals in an image forming apparatus according to a comparative example.

FIG. 6 is a timing chart illustrating a relationship between image reading and image formation for color originals in the image forming apparatus according to the comparative example.

### DESCRIPTION OF THE EMBODIMENTS

### Embodiment

Hereinbelow, an exemplary embodiment of the present invention is described with reference to the attached drawings.

(Image Forming Apparatus)

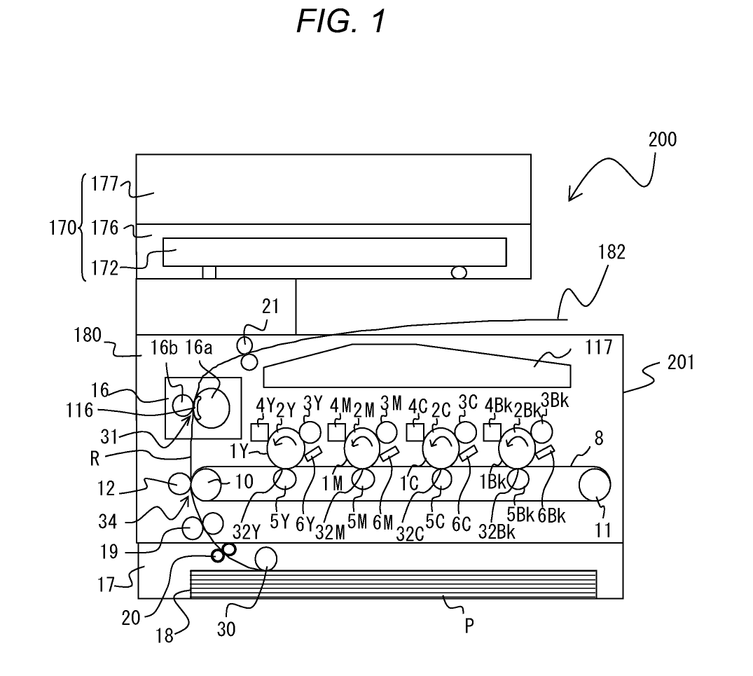

FIG. 1 is a sectional view of an image forming apparatus 200 according to the embodiment of the present invention. The image forming apparatus 200 includes an image forming unit 180, an image reading unit 176, and an original conveying unit 177.

(Image Forming Unit)

The image forming unit 180 is a four-station tandem type including four image forming stations 1Y, 1M, 1C, and 1Bk arranged in line. The yellow image forming station 1Y forms a yellow image. The magenta image forming station 1M forms a magenta image. The cyan image forming station 1C forms a cyan image. The black image forming station 1Bk forms a black image.

An intermediate transfer belt 8 is arranged under the four image forming stations 1Y, 1M, 1C, and 1Bk. The intermediate transfer belt 8 is stretched around a secondary transfer opposed roller 10 and a tension roller 11. In a secondary transfer unit 34, a secondary transfer roller 12 is arranged so as to be able to abut against the secondary transfer opposed roller 10 through the intermediate transfer belt 8. The intermediate transfer belt 8 is formed of a film that is made of a dielectric resin such as a polycarbonate resin, a polyethylene terephthalate resin, or a polyvinylidene fluoride resin.

A sheet feeding device 17 is arranged in a lower part of the image forming unit 180. The sheet feeding device 17 includes a cassette 18, a pickup roller 30, sheet feeding rollers 20, and a sheet feeding guide (not shown). The cassette 18 receives recording media P. The pickup roller 30 picks up recording media P one by one from the cassette 18. The sheet feeding rollers 20 feed to registration rollers 19 the recording medium P picked up by the pickup roller 30. The registration rollers 19 convey the recording medium P to the secondary transfer unit 34 in synchronization with an image formation timing of the image forming stations 1Y, 1M, 1C, and 1Bk.

A fixing device 16 is arranged in an upper part of the image forming unit 180. The recording medium P is conveyed from the sheet feeding device 17 to the fixing device 16 via the secondary transfer unit 34 along a conveyance path R extending in a vertical direction. The fixing device 16 includes a fixing film 16a provided with a heater 116 inside the fixing film 16a, the heater 116 being formed of a ceramic substrate and the like, and a pressure roller 16b which is held into pressure contact with the heater 116 with interposing the fixing film 16a between the pressure roller 16b and the heater 116. Note that, the pressure roller 16b may have a heat source provided inside the pressure roller 16b. On an upstream side of the fixing device 16 in a conveyance direction of the recording medium P, a conveyance guide (not shown) is provided so as to guide the recording medium P to a fixing nip portion 31 between the fixing film 16a and the pressure roller 16b. On a downstream side of the fixing device 16 in the conveyance direction of the recording medium P, delivery rollers 21 are provided. The delivery rollers 21 deliver the recording medium P conveyed from the fixing device 16 to a delivery tray 182 which is provided between the image forming unit 180 and the image reading unit 176.

The four image forming stations 1Y, 1M, 1C, and 1Bk include drum-type photosensitive members (hereinafter, referred to as photosensitive drums) 2Y, 2M, 2C, and 2Bk serving as image bearing members, respectively. Around the photosensitive drums 2Y, 2M, 2C, and 2Bk, there are provided chargers 3Y, 3M, 3C, and 3Bk, developing devices 4Y, 4M, 4C, and 4Bk, primary transfer rollers 5Y, 5M, 5C, and 5Bk, and cleaning blades 6Y, 6M, 6C, and 6Bk, respectively.

The developing devices 4Y, 4M, 4C, and 4Bk contain yellow developer (yellow toner), magenta developer (magenta toner), cyan developer (cyan toner), and black developer (black toner), respectively. An exposure device 117 is arranged above the image forming stations 1Y, 1M, 1C, and 1Bk. The exposure device 117 is a laser scanner unit including a laser emitting device, a polygon mirror, an f-θ lens, and a reflective mirror. The laser emitting device emits a laser beam modulated according to a time-series electric digital pixel signal serving as image information. The photosensitive drums 2Y, 2M, 2C, and 2Bk are exposed to the laser beam from the exposure device 117 at positions between the chargers 3Y, 3M, 3C, and 3Bk and the developing devices 4Y, 4M, 4C, and 4Bk, respectively. The photosensitive drums 2Y, 2M, 2C, and 2Bk are each a negatively-charged organic photosensitive member, in which a photosensitive layer of an organic photoconductor (OPC) is provided on an aluminum drum base. The primary transfer rollers 5Y, 5M, 5C, and 5Bk serving as primary transfer members cause the intermediate transfer belt 8 to abut against the respective photosensitive drums 2Y, 2M, 2C, and 2Bk. The primary transfer rollers 5Y, 5M, 5C, and 5Bk form primary transfer units 32Y, 32M, 32C, and 32Bk between the intermediate transfer belt 8 and the respective photosensitive drums 2Y, 2M, 2C, and 2Bk.

(Image Forming Process)

Hereinafter, an image forming process of forming an image on the recording medium P by the image forming apparatus 200 will be described. The photosensitive drums 2Y, 2M, 2C, and 2Bk are rotated at a predetermined process speed (hereinafter, referred to as image formation speed) V1 by a drive device (not shown) in a direction indicated by the arrows in FIG. 1 (counterclockwise direction). The image formation speed V1 may be represented as a rotation speed or surface speed of each of the photosensitive drums 2Y, 2M, 2C, and 2Bk. Also, the image formation speed V1 may be represented as a surface speed of the intermediate transfer belt 8. In synchronization with the rotation of the photosensitive drums 2Y, 2M, 2C, and 2Bk, the intermediate transfer belt 8 is rotated in a clockwise direction.

The chargers 3Y, 3M, 3C, and 3Bk uniformly charge the surfaces of the photosensitive drums 2Y, 2M, 2C, and 2Bk at a predetermined potential of a negative polarity by a charging bias applied from a charging bias power source (not shown), respectively. The exposure device 117 emits a laser beam modulated according to image information onto each of the surfaces of the photosensitive drums 2Y, 2M, 2C, and 2Bk uniformly charged by the chargers 3Y, 3M, 3C, and 3Bk. Accordingly, electrostatic latent images are formed on the surfaces of the photosensitive drums 2Y, 2M, 2C, and 2Bk.

More specifically, the exposure device 117 exposes the yellow image forming station 1Y to light of a yellow image, to thereby form a yellow electrostatic latent image on the photosensitive drum 2Y. A voltage of the same polarity and the substantially same potential as the charging polarity of the photosensitive drum 2Y is applied to a developing roller (not shown) of the yellow developing device 4Y. The developing device 4Y develops the electrostatic latent image formed on the photosensitive drum 2Y with yellow toner, to thereby visualize the electrostatic latent image as a yellow toner image. A voltage of a reverse polarity to that of the toner is applied to the primary transfer roller 5Y which is arranged inside the intermediate transfer belt 8. Then, the yellow toner image on the photosensitive drum 2Y is primarily transferred onto the intermediate transfer belt 8 at the primary transfer unit 32Y.

When the primary transfer of the yellow toner image onto the intermediate transfer belt 8 has been completed in the manner as described above, electrostatic latent images of a magenta image, a cyan image, and a black image are formed in the same manner as the yellow image. The respective electrostatic latent images are developed by the magenta, cyan, and black developing devices 4M, 4C, and 4Bk, and are visualized as a magenta toner image, a cyan toner image, and a black toner image. The respective toner images are sequentially transferred onto the intermediate transfer belt 8 by the primary transfer rollers 5M, 5C, and 5Bk at the primary transfer units 32M, 32C, and 32Bk, and the toner images are overlaid one on top of another. In this period, the secondary transfer roller 12 is not in contact with the intermediate transfer belt 8.

The cleaning blades 6Y, 6M, 6C, and 6Bk scrape off transfer residual toner, which remains on the photosensitive drums 2Y, 2M, 2C, and 2Bk after the primary transfer, from the photosensitive drums 2Y, 2M, 2C, and 2Bk, to thereby clean the surfaces of the photosensitive drums 2Y, 2M, 2C, and 2Bk, respectively. The secondary transfer roller 12 is brought into contact with the intermediate transfer belt 8 to form the secondary transfer unit 34.

At the secondary transfer unit 34, the images overlaid on the intermediate transfer belt 8 are secondarily transferred collectively onto the recording medium P which is conveyed from the sheet feeding device 17. The recording medium P is conveyed to the fixing device 16. The toner images transferred onto the recording medium P are fixed to the recording medium P by the fixing device 16, to thereby form a color image. The recording medium P having the color image formed thereon is delivered onto the delivery tray 182 by the delivery rollers 21.

(Original Conveying Unit)

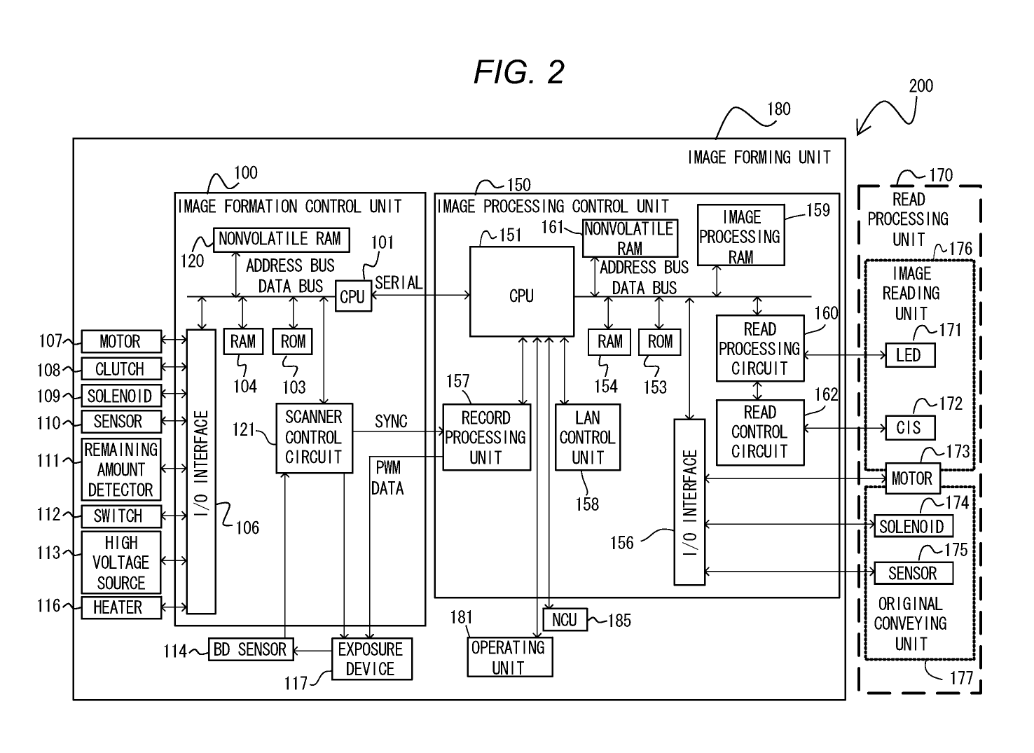

The original conveying unit 177 includes a motor 173, a solenoid 174, and a sensor 175 (FIG. 2). The original conveying unit 177 can continuously convey to the image reading unit 176 a plurality of originals stacked on an original stacking unit by separating one original from the others.

(Image Reading Unit)

The image reading unit 176 includes a contact image sensor (hereinafter, referred to as CIS) 172, in which light sources and image pickup elements are integrally housed in a case. The CIS 172 includes LEDs 171 (FIG. 2) of red, green, and blue (hereinafter, respectively referred to as R, G, and B) as the light sources. The image reading unit 176 provided with the CIS 172 can read a color image and a monochrome image.

For a color image, the image reading unit 176 sequentially turns on the LEDs 171 of R, G, and B to read the color image. For a monochrome image, the image reading unit 176 turns on the LED of G to read the monochrome image. Therefore, a reading time of the color image is three times as long as a reading time of the monochrome image when assuming that the color image and the monochrome image are read at the same resolution. In other words, a color image reading speed Vrc for reading the color image is one-third of a monochrome image reading speed Vrm for reading the monochrome image.

As a system for reading an image, there are a flow-reading mode, in which an original moves above the stationary CIS 172, and a fixed-reading mode, in which the CIS 172 moves under a stationary original placed on a platen glass. The color image reading speed Vrc in the flow-reading mode may be represented as an original conveyance speed of a color original which is conveyed above the CIS 172 by the original conveying unit 177. The color image reading speed Vrc in the fixed-reading mode may be represented as a moving speed of the CIS 172 with respect to the stationary color original. The monochrome image reading speed Vrm in the flow-reading mode may be represented as an original conveyance speed of a monochrome original which is conveyed above the CIS 172 by the original conveying unit 177. The monochrome image reading speed Vrm in the fixed-reading mode may be represented as a moving speed of the CIS 172 with respect to the stationary monochrome original.

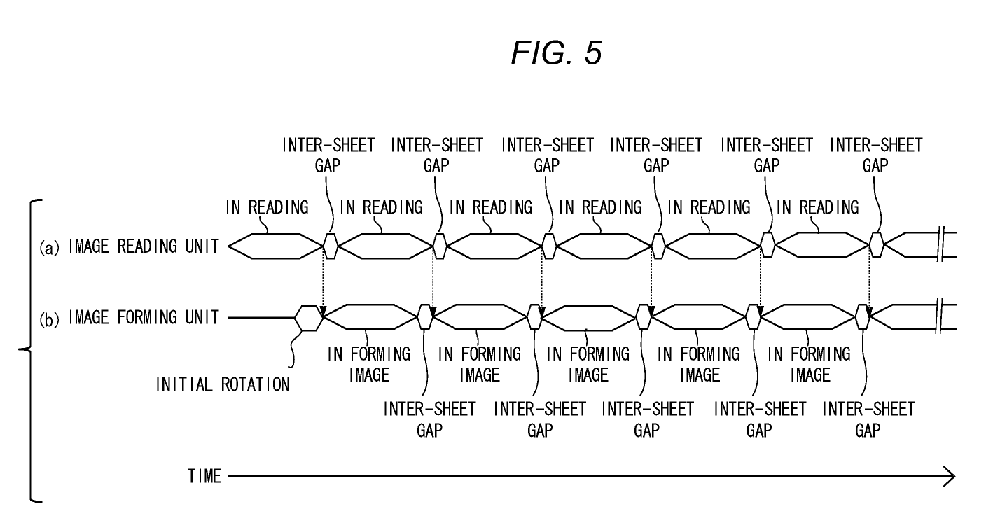

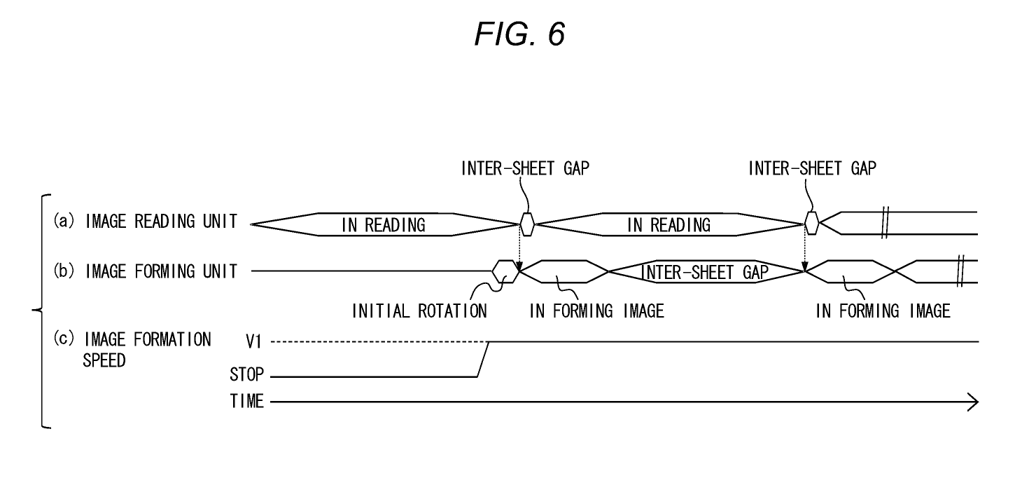

For more details, referring to FIGS. 5 and 6, a relationship between image reading and image formation according to a comparative example will be described. FIG. is a timing chart illustrating a relationship between image reading and image formation for a monochrome original in the image forming apparatus. Part (a) of FIG. 5 represents timings of an image reading operation for a monochrome original which is performed by the image reading unit. Part (b) of FIG. 5 represents timings of forming a monochrome image on a recording medium by the image forming unit. In the comparative example, the image reading speed for reading image information of a monochrome original by the image reading unit, and the image formation speed for forming a monochrome image on a recording medium by the image forming unit are equal to each other. Therefore, the image forming unit can always form the image on the recording medium after the image reading unit completes reading the image information of the original.

FIG. 6 is a timing chart illustrating a relationship between image reading and image formation for a color original in the same image forming apparatus. Part (a) of FIG. 6 represents timings of an image reading operation for a color original which is performed by the image reading unit. Part (b) of FIG. 6 represents timings of forming a color image on a recording medium by the image forming unit. Part (c) of FIG. 6 represents the image formation speed V1. The image reading operation for a color original is performed by a point sequential method of R, G, and B, and hence the speed for reading image information of a color original by the image reading unit is one-third of the speed for forming a color image by the image forming unit.

Therefore, at the time when the image forming unit has completed forming the image on the recording medium based on the image information of the original which is read by the image reading unit, the image reading unit is in the process of the operation of reading image information of a succeeding original. Therefore, the image forming unit cannot start the succeeding image forming operation immediately after the preceding image forming operation is completed, and hence the inter-sheet gap increases. Even during the inter-sheet gap, the image forming unit rotates the photosensitive drums and the intermediate transfer belt in a state in which the photosensitive drums are held into contact with the intermediate transfer belt, until image formation for the succeeding original is started. Consequently, the photosensitive drums, the cleaning blades pressed against the photosensitive drums, the intermediate transfer belt, and other members are worn out.

The image forming apparatus 200 of this embodiment includes the image forming unit 180 of the four-station tandem type and the image reading unit 176 including the CIS 172. To address the above-mentioned problem in the image forming apparatus 200, the color image reading speed Vrc may be increased so that the color image reading speed Vrc becomes equal to the image formation speed V1. However, in order that the CIS 172 scans a color original only once to read a color image, it is necessary to improve the performance of the CIS 172 by increasing the number of output channels of the CIS 172. Therefore, the cost of the image reading unit 176 increases. Further, in order that the CIS 172 scans a color original three times to read a color image, the moving speed of the CIS 172 and the conveyance speed of the color original are increased accordingly. Therefore, higher performance is required for the motor, and the cost of the image reading unit 176 thus increases. In view of the above, in the low-cost and small-size image forming apparatus 200 according to this embodiment, neither the number of output channels of the CIS 172 nor the speed of the motor is increased. Further, the color image reading speed Vrc is set at one-third of the monochrome image reading speed Vrm. The monochrome image reading speed Vrm is set equal to the image formation speed V1.

(Control Units of Image Forming Apparatus)

FIG. 2 is a block diagram illustrating configurations of control units of the image forming apparatus 200 according to the embodiment of the present invention. The image forming unit 180 of the image forming apparatus 200 includes an image formation control unit 100 and an image processing control unit 150.

(Image Formation Control Unit)

The image formation control unit 100 controls the chargers 3Y, 3M, 3C, and 3Bk, the exposure device 117, the developing devices 4Y, 4M, 4C, and 4Bk, the primary transfer rollers 5Y, 5M, 5C, and 5Bk, the sheet feeding device 17, and the fixing device 16 of the image forming unit 180. The image formation control unit 100 includes a CPU 101 and a motor driver circuit board (not shown). The CPU 101 controls the image formation which is performed by the image forming unit 180. A read only memory (ROM) 103 stores a program for controlling an apparatus main body 201 (image formation control program). The CPU 101 sequentially reads the program from the ROM 103, and executes the program thus read. The CPU 101 is connected to the ROM 103, a random access memory (RAM) 104, an I/O interface 106, a nonvolatile RAM 120, and a scanner control circuit 121 via an address bus and a data bus. The RAM 104 serving as a main memory is used as a storage area for input data and a work storage area. The nonvolatile RAM 120 is used as a storage area for parameters regarding the image forming operation.

The I/O interface 106 is connected to a motor 107, a clutch 108, and a solenoid 109 for driving the sheet feeding system, the conveyance system, and the optical system, and further connected to a sensor 110 for detecting the conveyed recording medium P. In each of the developing devices 4Y, 4M, 4C, and 4Bk, there is arranged a toner remaining amount detector 111 for detecting a toner amount in each of the developing devices 4Y, 4M, 4C, and 4Bk. The toner remaining amount detector 111 is connected to the I/O interface 106, and an output signal from the toner remaining amount detector 111 is input to the I/O interface 106.

A switch 112 is used for detecting home positions of loads on the motor 107, the clutch 108, the solenoid 109, the sensor 110, and the toner remaining amount detector 111. A signal from the switch 112 is input to the I/O interface 106. A high voltage source 113 is connected to the I/O interface 106. The high voltage source 113 supplies high voltages to the chargers 3Y, 3M, 3C, and 3Bk, the developing devices 4Y, 4M, 4C, and 4Bk, and the transfer rollers 5Y, 5M, 5C, and 5Bk in accordance with instructions from the CPU 101. The heater 116 of the fixing device 16 is connected to the I/O interface 106. An AC voltage is supplied to the heater 116 in accordance with ON/OFF signals.

(Image Processing Control Unit)

The image processing control unit 150 performs image processing on an image signal from an externally-connected device such as a personal computer (hereinafter, referred to as PC), or from a read processing unit 170, to thereby create image information to be used for forming latent images on the photosensitive drums 2Y, 2M, 2C, and 2Bk by the exposure device 117. In addition, the image processing control unit 150 may store the image information, which is created by performing image processing on the image signal from the read processing unit 170, in the externally-connected device such as a PC or a storage medium such as a USB memory connected to an operating unit 181.

A read only memory (ROM) 153 stores a program for controlling the image processing that is performed by the image processing control unit 150 (image processing control program). A CPU 151 provided to the image processing control unit 150 sequentially reads the program from the ROM 153, and executes the program thus read. Further, a random access memory (RAM) 154 serving as a main memory is used as a storage area for input data and a work storage area. A record processing unit 157 performs image processing on the image signal from the read processing unit 170 or from the externally-connected device such as a PC, to thereby generate image information (PWM data) to be used for performing pulse width modulation on the laser beam emitted from the light source of the exposure device 117. The record processing unit 157 controls the exposure device 117 to emit the laser beam subjected to the pulse width modulation based on the image information. The photosensitive drums 2Y, 2M, 2C, and 2Bk are irradiated with the pulse-width modulated laser beam so that latent images are formed on the photosensitive drums 2Y, 2M, 2C, and 2Bk.

Further, the laser beam is detected by a beam detecting sensor (BD sensor) 114 provided in a non-image region, and the BD sensor 114 generates a BD signal (synchronization signal in a main scanning direction) for achieving synchronous start of image signal writing in the respective scanning operations. The BD signal is input to the scanner control circuit 121. The scanner control circuit 121 uses the BD signal to control rotation of a polygon motor (not shown) of the exposure device 117. Further, the scanner control circuit 121 outputs an image synchronization signal to the image processing control unit 150.

A nonvolatile RAM 161 is used as a storage area for parameters regarding the image processing. An I/O interface 156 is connected to the motor 173 provided in the image reading unit 176 and the original conveying unit 177 of the read processing unit 170. Further, the I/O interface 156 is connected to the solenoid 174 and the sensor 175 provided in the original conveying unit 177. A read processing circuit 160 controls ON/OFF of the LEDs 171 of the image reading unit 176. Further, the read processing circuit 160 drives the CIS 172 of the image reading unit 176 through a read control circuit 162, and processes image data from the CIS 172. An image processing RAM 159 is used as a storage area for temporarily storing data received by the read processing circuit 160 or data from the externally-connected device such as a PC when image processing is performed on the data. A LAN control unit 158 controls communication with the externally-connected device such as a PC, which is connected through a LAN cable.

The ROM 153, the RAM 154, the I/O interface 156, the record processing unit 157, the image processing RAM 159, the read processing circuit 160, and the nonvolatile RAM 161 are controlled by the CPU 151. The CPU 151 also controls the operating unit 181 that is a user interface for a user to operate the image forming apparatus 200, and a network control unit (NCU) 185 of a facsimile apparatus. The CPU 101 of the image formation control unit 100 and the CPU 151 of the image processing control unit 150 are connected through start-stop or clock synchronous serial communication. Through the serial communication, a timing of outputting image data to an engine unit of the image forming apparatus 200 is controlled, and also activation, shutdown, and entry to sleep mode of the image forming apparatus 200 are controlled.

(Control of Image Formation Speed)

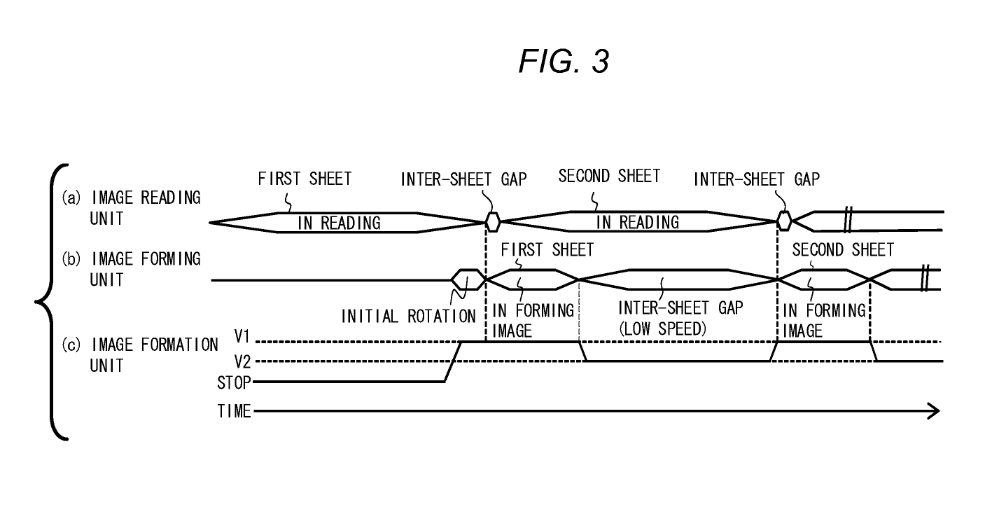

FIG. 3 is a timing chart illustrating a relationship between image reading and image formation for a color original in the image forming apparatus 200 according to the embodiment of the present invention. Part (a) of FIG. 3 represents timings of an image reading operation for a color original that is performed by the image reading unit 176. Part (b) of FIG. 3 represents timings of forming a color image on a recording medium by the image forming unit 180. Part (c) of FIG. 3 represents the image formation speed of the image forming unit 180. As described above, the image formation speed corresponds to the rotation speed or surface speed of each of the photosensitive drums 2Y, 2M, 2C, and 2Bk, or the surface speed of the intermediate transfer belt 8.

When a copy button provided on the operating unit 181 of the image forming apparatus 200 is depressed, an original set on the original conveying unit 177 of the read processing unit 170 is conveyed to the image reading unit 176. Then, the image reading unit 176 reads an image of the original. Through initial rotation prior to the end of reading the image information of the preceding first original, the image forming unit 180 accelerates the rotation speed or surface speed of each of the photosensitive drums 2Y, 2M, 2C, and 2Bk, or the surface speed of the intermediate transfer belt 8 to the image formation speed V1. Then, when the reading of the image information of the preceding original has been completed, the image forming unit 180 starts an image forming operation for the first original at the image formation speed V1. Subsequently to the reading of the image information of the preceding original, the image reading unit 176 starts reading image information of a succeeding second original.

At this time, to read an image of a color original, the image reading unit 176 operates at the color image reading speed Vrc that is one-third of the image formation speed V1 of the image forming unit 180 (Vrc=V1×⅓). In other words, a period of time required from the start to end of the image reading for a color original by the image reading unit 176 is three times as long as a period of time required from the start to end of the image formation for the original by the image forming unit 180. Consequently, the image formation for the preceding first original ends prior to the end of reading the image information of the succeeding second original. Therefore, when the image formation for the preceding original has been completed, the image forming unit 180 decelerates the rotation speed of each of the photosensitive drums 2Y, 2M, 2C, and 2Bk or the surface speed of the intermediate transfer belt 8 to an image formation speed V2 that is lower than the image formation speed V1. In other words, the image forming unit 180 controls the image formation speed so that the image formation speed V2 to be set during the period between the image formation for the preceding original and the subsequent image formation for the succeeding original is lower than the image formation speed V1 during the image formation. Accordingly, unnecessary wear of the photosensitive drums, the cleaning blades, the intermediate transfer belt, or other members can be reduced.

At the time when the image forming unit 180 has completed the image formation for the first sheet, the image reading unit 176 is in the process of reading image information of the succeeding original among the originals conveyed continuously. Before the image reading unit 176 completes reading the image information of the succeeding original, the image forming unit 180 accelerates the rotation speed or surface speed of each of the photosensitive drums 2Y, 2M, 2C, and 2Bk, or the surface speed of the intermediate transfer belt 8 from V2 to V1. When the image reading unit 176 has completed reading the image information of the succeeding original, the image forming unit 180 forms an image of the succeeding second original at the image formation speed V1. At this time, in a case where a third original is conveyed, the image reading unit 176 starts reading image information of the succeeding third original. The image formation for the second original preceding the third original ends prior to the end of reading the image information of the succeeding third original. Therefore, when the image formation for the second original has been completed, the image forming unit 180 decelerates the rotation speed or surface speed of each of the photosensitive drums 2Y, 2M, 2C, and 2Bk, or the surface speed of the intermediate transfer belt 8 from V1 to V2. Such an operation continues until image formation for the last original is completed.

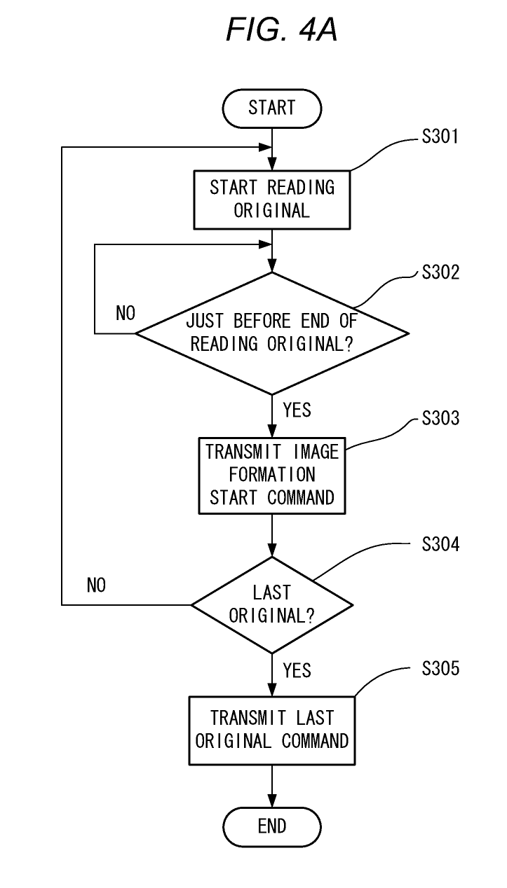

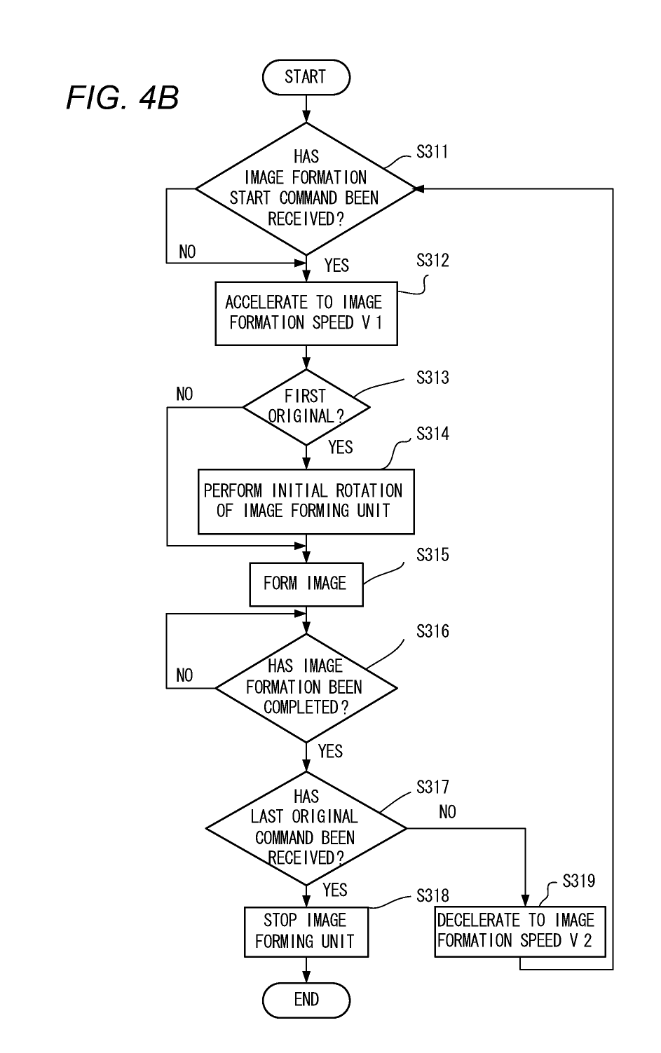

FIGS. 4A and 4B are flow charts illustrating operation procedures of the image reading and the image formation for a color original in the image forming apparatus 200 according to the embodiment of the present invention. FIG. 4A is a flow chart of the image reading performed by the CPU 151 of the image processing control unit 150. FIG. 4B is a flow chart of the image formation performed by the CPU 101 of the image formation control unit 100.

Referring to FIG. 4A, when the copy button on the operating unit 181 of the image forming apparatus 200 is depressed, the CPU 151 causes the image reading unit 176 to start reading an original (S301). Note that, the original is set on the original conveying unit 177 in the read processing unit 170. The CPU 151 determines whether or not the reading of the original is just about to end (S302). When it is determined that the reading of the original is not about to end (NO in S302), the CPU 151 continues to monitor the reading of the original until the reading of the original becomes just about to end. For example, whether or not the reading of the original is just about to end is determined with reference to a predetermined period of time that is preset based on a period of time required for preparing the image formation.

When it is determined that the reading of the original is just about to end (YES in S302), the CPU 151 transmits an image formation start command to the CPU 101 of the image formation control unit 100 (S303). Further, the CPU 151 determines whether or not the read original is the last original (S304). When the read original is not the last original (NO in S304), the CPU 151 subsequently starts reading a succeeding original (S301), and repeats this operation until the last original. When it is determined that the read original is the last original (YES in S304), the CPU 151 transmits a last original command to the CPU 101 (S305). After transmitting the last original command, the CPU 151 ends the operation of reading an original.

Referring to FIG. 4B, the CPU 101 of the image formation control unit 100 determines whether or not the image formation start command has been received from the CPU 151 of the image processing control unit 150 (S311). Until it is determined that the image formation start command has been received (NO in S311), the CPU 101 maintains the image forming stations 1Y, 1M, 1C, and 1Bk in a stopped state. When the CPU 101 determines that the image formation start command has been received (YES in S311), the CPU 101 accelerates the image formation speed of each of the image forming stations 1Y, 1M, 1C, and 1Bk to the image formation speed V1 (S312). The CPU 101 determines whether or not the image formation is to be performed on the first original (S313). When the CPU 101 determines that the image formation is to be performed on the first original (YES in S313), the CPU 101 performs initial rotation such as temperature control for the fixing device and activation of the polygon motor (S314), and thereafter starts the image formation (S315). When the CPU 101 determines that the image formation is not to be performed on the first original, that is, when the image formation is to be performed on one of the second and subsequent successive originals (NO in S313), the CPU 101 performs the image formation without performing the initial rotation (S315). This is because the temperature control for the fixing device and the activation of the polygon motor have already been performed after the image formation for the first original.

The CPU 101 determines whether or not the image formation has been completed (S316). When it is determined that the image formation has not been completed (NO in S316), the CPU 101 continues to monitor the image formation until the image formation is completed. When it is determined that the image formation has been completed (YES in S316), the CPU 101 determines whether or not the last original command has been received from the CPU 151 of the image processing control unit 150 (S317). When the CPU 101 determines that the last original command has been received from the CPU 151 (YES in S317), the CPU 101 stops the operation of the image forming unit 180 without decelerating the image formation speed of the image forming unit 180 (S318), and ends the image forming operation.

In a state in which no succeeding image formation start command has been received, when the CPU 101 determines that the last original command has not been received from the CPU 151 (NO in S317), the image formation for the preceding original has been completed prior to the end of reading the image information of the succeeding original. Therefore, the CPU 101 decelerates the image formation speed of each of the image forming stations 1Y, 1M, 1C, and 1Bk to the image formation speed V2 (S319). The CPU 101 continues to maintain the image formation speed V2, and waits for the reception of the succeeding image formation start command from the CPU 151 (S311). When the CPU 101 has received the image formation start command, the CPU 101 again accelerates to the image formation speed V1 (S312). The succeeding original in this case corresponds to one of the second and subsequent sheets (NO in S313), and hence the CPU 101 starts image formation for the original without performing the initial rotation (S315). The CPU 101 repeats this operation until the last original command is received from the CPU 151.

With the image forming apparatus according to the embodiment of the present invention, there is no such case that the image forming unit 180 always continues to operate at the image formation speed V1 while the image reading unit 176 is reading an original. Specifically, the image formation speed V1 is decelerated to the image formation speed V2 while the image reading unit 176 is reading an original. Accordingly, the unnecessary wear of the photosensitive drums, the cleaning blades, or other members is eliminated during the period other than the period of the image formation. Thus, the frequency of cartridge replacement is reduced, and further the life of the intermediate transfer belt can be increased. Further, the image forming apparatus according to the embodiment of the present invention does not require any mechanism for moving the intermediate transfer belt (recording medium conveying belt) apart from the photosensitive drums. As a result, the wear of the photosensitive drums, the cleaning blades, or other members of the image forming apparatus for color copy can be suppressed with no increase in size and cost of the image forming apparatus. Thus, the frequency of cartridge replacement can be reduced, and the life of the intermediate transfer belt can be increased.

Note that, the description of the embodiment of the present invention is directed to the image forming apparatus to be used for image reading and image formation for a color original, but the present invention is not limited thereto. Specifically, the present invention is also applicable to an image forming apparatus to be used for image reading and image formation for a monochrome original. More specifically, the present invention is also applicable to an image forming apparatus configured such that the speed for forming an image by the image forming unit is higher than the speed for reading image information of a monochrome original by the image reading unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-146562, Jun. 28, 2010, which is hereby incorporated by reference herein in its entirety.

What is claimed is:

1. An image forming apparatus, comprising:
an image reading unit configured to continuously read image information from a plurality of originals; and
an image forming unit configured to form, on a recording medium at a first speed, an image based on image information of a first original which is read by the image reading unit,
wherein, when the image forming unit has completed forming the image based on the image information of the first original before the image reading unit completes reading image information of a second original succeeding to the first original, the image forming unit is decelerated to a second speed lower than the first speed.

2. An image forming apparatus according to claim 1, wherein the image forming unit comprises an image bearing member, and
wherein the first speed and the second speed each comprises one of a rotation speed and a surface speed of the image bearing member.

3. An image forming apparatus according to claim 1, wherein the image forming unit comprises an intermediate transfer belt, and
wherein the first speed and the second speed each comprises a surface speed of the intermediate transfer belt.

4. An image forming apparatus according to claim 1, wherein the image reading unit comprises an original conveying unit, and
wherein an original conveyance speed of the original conveying unit is lower than the first speed.

5. An image forming apparatus according to claim 1,
wherein the image forming unit comprises:
an image processing control unit configured to perform image processing on the image information from the image reading unit; and
an image formation control unit configured to control a formation of the image, and
wherein, when it is determined that reading of the image information is just about to end, the image processing control unit transmits an image formation start command to the image formation control unit.

6. An image forming apparatus according to claim 1, wherein the image forming unit comprises:
an image processing control unit configured to perform image processing on the image information from the image reading unit; and
an image formation control unit configured to control a formation of the image, and
wherein, when it is determined that the image information is image information of a last original, the image processing control unit transmits a last original command to the image formation control unit.

7. An image forming apparatus according to claim 1, wherein, when the image information is image information of a last original, the image forming unit is stopped without decelerating to the second speed.
